(19) United States
(12) Patent Application Publication
(10) Pub. No.: US 2021/0163054 A1
(43) Pub. Date: Jun. 3, 2021

(54) PUSH CHAIR CARRIAGE AND PUSH CHAIR COMPRISING SUCH PUSH CHAIR CARRIAGE

(71) Applicants: Camille De Vrede, Maastricht (NL); Bastjan Otten, Maastricht (NL)

(72) Inventors: Camille De Vrede, Maastricht (NL); Bastjan Otten, Maastricht (NL)

(21) Appl. No.: 16/629,601

(22) PCT Filed: Jul. 18, 2018
(86) PCT No.: PCT/NL2018/050499

§ 371 Date: Jan. 9, 2020

(30) Foreign Application Priority Data
Jul. 18, 2017 (NL) 2019268

(51) Int. Cl. B62B 5/06; B62B 5/08; B62B 7/06

(52) U.S. Cl. CPC B62B 5/067; B62B 5/08; B62B 2205/02; B62B 2205/121; B62B 7/06

(57) ABSTRACT

A foldable push chair carriage includes an upper frame to support a child, a lower frame to support the upper frame, where the upper frame is pivotable with respect to the lower frame. The lower frame includes two side panels connected to each other by one or more connecting rods, where each side panel includes a front side panel part and a back side panel part, where the front side panel part and the back side panel part are pivotable with respect to each other between an unfolded position in which the front side panel part and the back side panel part extend at an angle of 160-180 degrees with respect to each other and a folded position in which the front side panel part and the back side panel part extend at an angle of 0-40 degrees with respect to each other.

### CROSS-REFERENCE TO RELATED APPLICATIONS:

This application is the National Stage of International Application No. PCT/NL2018/050499, filed Jul. 18, 2018, which claims the benefit of Netherlands Application No. 2019268, filed Jul. 18, 2017, the contents of which is incorporated by reference herein.

### FIELD OF THE INVENTION

The present invention relates to a foldable push chair carriage, in particular a push chair carriage for supporting a child and that can be arranged in a folded state and an unfolded state. The invention further relates to a push chair comprising such push chair carriage.

### BACKGROUND OF THE INVENTION

Push chairs are used to transport children in a sitting position and/or lying position. Push chairs are also referred to as strollers or buggies. Some types of push chairs are also suitable to support a carry cot and/or a child car seat.

A known embodiment of a foldable push chair carriage comprises an upper frame to support a child and a lower frame to support the upper frame, wherein the upper frame is pivotable with respect to the lower frame about a first rotation axis. The lower frame is mounted on multiple wheels, for example two front wheels and two back wheels to allow the push chair carriage to be rolled over a supporting ground surface.

Generally, there is a need to provide a push chair carriage that can be folded to a small volume such that the push chair carriage can be easily stored and/or transported, for example in a car trunk. On the other hand it is desirable to provide a push chair carriage that has, in the unfolded state, a rigid construction.

### SUMMARY OF THE INVENTION

Therefore, it is an aim of the present invention to provide a push chair carriage that can be folded to relatively small dimensions in the folded state, and that provides in the unfolded state a rigid structure of the lower frame as basis of the push chair carriage.

The invention provides a foldable push chair carriage that can be arranged in a folded state and an unfolded state comprising:

an upper frame to support a child seat,

a lower frame to support the upper frame,

wherein the upper frame is pivotable with respect to the lower frame about a first rotation axis,

characterized in that the lower frame comprises two side panels connected to each other by one or more connecting rods, wherein each side panel comprises a front side panel part and a back side panel part, wherein the front side panel part and the back side panel part are pivotable with respect to each other between an unfolded position in which the front side panel part and the back side panel part extend at an angle of 160-180 degrees with respect to each other and a folded position in which the front side panel part and the back side panel part extend at an angle of 0-40 degrees with respect to each other,

wherein each side panel comprises a front wheel and a back wheel.

In accordance with the invention each side panel of the push chair carriage is foldable to a folded state in which the side panels of the push chair carriage on which the front wheels and back wheels are mounted, also fold to a folded position. The advantage of these folding side panels is that the lower frame can be folded into a relatively thin volume which is advantageous for transport and/or storage.

In the unfolded position, the front side panel part and the back side panel part of a side panel extend at an angle of 160-180 degrees, preferably 170-180 degrees, more preferably 180 degrees. This provides a rigid structure between the front wheel and back wheel of each side panel. Also, the connecting rods between the side panels may provide a rigid connection between the two side panels. This results in a rigid construction of the lower frame. As the lower frame forms the basis of the push chair carriage this rigid construction provides a feeling of reliability to the operator of the push chair carriage, for example a parent of a child supported by the push chair carriage.

The side panel may be formed by any structure that provides, in the unfolded state, a rigid connection between the front wheel, the back wheel and the pivotal connection point of the upper frame, for example a rod or a beam. Preferably, the front side panel part and the back side panel part are board or plate shaped elements.

The side panels may be provided at opposite sides of the push chair carriage.

Each of the side panels may extend, in the unfolded position, in a substantially vertical plane parallel to a main drive direction of the push chair carriage.

In the folded position of the side panels, the front side panel part and the back side panel part of a side panel extend at an angle of 0-40 degrees with respect to each other, preferably at an angle of 0-20 degrees with respect to each other, more preferably at an angle of less than 10 degrees with respect to each other, for example 0 degrees.

The front side panel part and the back side panel part may, in the unfolded position, mainly extend in the main driving direction of the push chair. In the folded position the front side panel part and the back side panel part may mainly extend in a direction perpendicular to the main driving direction.

In an embodiment, each side panel comprises a front support rod and a back support rod, wherein one end of the front support rod and one end of the back support rod are pivotably connected to each other. The front support rod and the back support rod may provide support to the upper frame, in particular to the pivotal connection between the upper frame and the lower frame. This pivotal connection may be provided on one or both of the front support rod and the back support rod.

The rotation axis of the pivotal connection between the front support rod and the back support rod may coincide with the first rotation axis between the upper frame and the lower frame.

The second end of the front support rod may support the front wheel and the second end of the back support rod may support the back wheel. This support of the front wheel and the back wheel may be directly, i.e. the front wheel and back wheel are directly mounted on the front support rod and the back support rod, but also indirectly, i.e. other parts of the lower frame are arranged between the front wheel and the front support rod and between the back wheel and the back support rod. For example the front wheel and back wheel may be connected to the front side panel part and the back side panel part, while the front side panel part and the back side panel part are connected to the front support rod and the back support rod, respectively.

In an embodiment, at least one of the one or more connecting rods is mounted between the front support rod of one side panel and the front support rod of the other side panel, and

at least one of the one or more connecting rods is mounted between the back support rod of one side panel and the back support rod of the other side panel. One or more connecting rods are provided between the two side panels to provide a rigid connection between the two side panels. Since the distance between the front support rods and the distance between the back support rods may remain the same between the folded position and the unfolded position of the side panels, the front support rods and back support rods are very suitable for mounting of the connecting rods between the two side panels.

The connecting rods may be any rigid construction between the two side panels. The connecting rod may be shaped for another function, for example for supporting the feet of a child supported by the push chair carriage.

In an embodiment, the front support rod comprises an upper part and a lower part, wherein the lower part is rotatably mounted about its longitudinal axis with respect to the upper part, and wherein the lower part is fixedly mounted to the front side panel part,

wherein the back support rod comprises an upper part and a lower part, wherein the lower part is rotatably mounted about its longitudinal axis with respect to the upper part, and wherein the lower part is fixedly mounted to the back side panel part,

wherein one end of the upper part of the front support rod and one end of the upper part of the back support rod are pivotably connected to each other, and

wherein the front side panel part and the back side panel part are pivotably connected to each other by a pivot element.

In this embodiment, the lower parts of the front support rod and the back support rod will rotate together with the front side panel part and the back side panel part between the unfolded position and the folded position. The upper parts will not rotate about their longitudinal axes to allow the front support rod and back support rod to pivot with respect to each other.

In such embodiment, each end of a connecting rod between the front support rods may comprise a sleeve through which the respective front support rod is guided so that the sleeves may rotate with respect to the front support rods to allow rotation of the front side panel part. Similarly, each end of a connecting rod between the back support rods may comprise a sleeve through which the respective back support rod is guided so that the sleeves may rotate with respect to the back support rods to allow rotation of the back side panel part.

In an alternative embodiment, the front side panel part is pivotably mounted on the front support rod and the back side panel part is pivotably mounted on the back support rod, and the front side panel part and the back side panel part are pivotably connected to each other by a pivot element. To allow pivoting of the front and back side panel parts with respect to each other, the front side panel part and the back side panel part are preferably pivotably mounted on the front support rod and the back support rod, respectively.

In such embodiment, the front side panel part may comprise a front support rod sleeve rotatably arranged on the front support rod, and the back side panel part may comprise a back support rod sleeve rotatably arranged on the back support rod.

The front support rod may extend through the front support rod sleeve and the back support rod may extend through the back support rod sleeve. The sleeves may have an inner cylindrical surface that cooperates with an outer cylindrical surface of the respective support rod to form a pivotal connection between front support rod and the front side panel part and between the back support rod and the back side panel part, respectively.

The front side panel part may have multiple front support rod sleeves and the back side panel part may have multiple back support rod sleeves.

In an embodiment, the pivot element is a double pivot axis element, wherein one end of the double pivot axis element is pivotably connected to the front side panel part and the other opposite end of the double pivot axis element is pivotably connected to the back side panel part. The front side panel part and the back side panel part may have a substantial thickness, for example a thickness that substantially corresponds with the diameters of the front support rod and the back support rod. To allow the front side panel part and the back side panel part to rotate until they are next to each other extending in a parallel direction, i.e. at an angle of about 0 degrees, a first pivotal connection of the double pivot axis element is connected to the front side panel part and a second pivotal connection of the double pivot axis element is connected to the back side panel part. The first pivotal connection is spaced from the second pivotal connection, for example with a distance substantially equal to the thickness of one of the front side panel part and the back side panel part.

Alternatively, the pivot element may be constructed such that the first side panel part and the second side panel part are pivotable with respect to each other about a single rotation axis.

In an embodiment, the front wheel is mounted on the front side panel part and the back wheel is mounted on the back side panel part. Since the front wheel and the back wheel are mounted on the front side panel part and the back side panel part, respectively, the front wheel and the back wheel will follow the rotation of the front side panel part and the back side panel part, when the front side panel part and the back side panel part are pivoted between the unfolded position and the folded position.

In an embodiment, the upper frame comprises a seat support part to support a child seat and a push bar part configured to push the push chair. The seat support part may support a child seat, for instance a seat made of cloth that may be reinforced by a number of reinforcement plates.

In an embodiment, the seat support part and the push bar part are substantially U-shaped having legs, wherein the legs of the push bar part are telescopically arranged in or on the legs of the seat support part. In this embodiment the seat support part and the push bar part are telescopically movable with respect to each other. This telescopic movement may for example be used to adapt a height of the push bar part. In addition or alternatively, the telescopic movement may also be used for other purposes, for example to operate a locking device that locks the push chair in the unfolded state.

In an embodiment, the push chair carriage comprises a telescopic operating frame, wherein one end of the operating frame is pivotably about a second rotation axis mounted to the upper frame and another end of the operating frame is pivotably about a third rotation axis mounted to the lower frame, wherein the first rotation axis, the second rotation axis and the third rotation axis are parallel and spaced from each other.

The operating frame is provided to guide the movement of the upper frame with respect to the lower frame while moving the push chair carriage between the folded state and the unfolded state, or vice versa. The operating frame may also be used to move the front side panel part and the back side panel part of each side panel out of the folded position when the upper frame is moved from the folded position to the unfolded position. In such embodiment the operating frame is also used to operate the folding of the lower frame in dependence of the position of the upper frame.

Further, the operating frame may be configured to hold the front side panel part and the back side panel part in the unfolded position.

In an embodiment, the operating frame is configured to push the front side panel part and the back side panel part of each side panel from the folded position towards the unfolded position, when the upper frame is moved from the folded position towards the unfolded position.

In an embodiment, the push chair carriage comprises a locking device to lock the push chair carriage in the unfolded position. To avoid that the push chair carriage inadvertently moves out of the unfolded state towards the folded state, a locking device may be provided to lock the push chair carriage in the unfolded state.

The locking device may for example be provided in the operating frame, and operated by telescopic movement of the push bar part of the upper frame with respect to the seat support part of the upper frame.

The locking device may comprise hooks that are arranged on a first part of the operating frame that snap on a second part of the operating frame, when the first part and the second part of the operating frame are moved against each other. Any other embodiment of a locking device to lock the push chair carriage in the unfolded position may also be used.

In an embodiment, the upper frame, the front side panel parts, the back side panel parts, the front wheels and the back wheels are arranged substantially parallel to each other in the folded state of the push chair carriage. This provides a package of small dimensions, in particular a small thickness when the push chair carriage is in the folded state. Such package is very suitable for storage and transport.

It is remarked that the front wheels and/or back wheels may be relatively big, while the lower frame can still be folded into a package of small dimensions, in particular a small thickness. In an embodiment, the side panel comprises a biasing element to bias the front side panel part and the back side panel part from the unfolded position at least partially towards the folded position. In the unfolded position the front side panel part and the back side panel part may extend at an angle of about 180 degrees. To ensure that the front side panel part and the back side panel part easily move towards the folded position, a biasing element may be provided to bias the front side panel part and the back side panel part from the unfolded position at least partially towards the folded position. In an embodiment comprising a double pivot axis element, this biasing element may be a pre-tensioned rubber block that is arranged next to the double pivot axis element.

The invention further relates to a push chair comprising:

the push chair carriage of any of the embodiments described herein, and

a child seat supported by the upper frame of the push chair carriage.

The child seat may be any device to support a child. Preferably, the child seat is made of cloth or similar flexible material that can be folded and/or compressed when the push chair carriage is brought into the folded state. The child seat may have supporting or reinforcement elements to keep the child seat in a desired shape and/or to provide additional support to a child supported by the seat. Also the supporting or reinforcement elements should not prevent the push chair carriage to be moved to the folded state.

Additionally or alternatively, the upper frame of the push chair carriage according to the invention may also be used to support a carry cot, a child car seat and/or other devices that are used to transport children in a sitting position and/or lying position. In some embodiments, it may be needed to take the supporting device, e.g. a seat, cot or car seat, from the push chair carriage before the push chair carriage can be moved from the unfolded state to the folded state.

### BRIEF DESCRIPTION OF THE DRAWINGS

An embodiment of a push chair carriage according to the invention will now be described in further detail, by way of example only, with reference to the accompanying drawings, in which:

FIG. 1 shows a first isometric view of an embodiment of a push chair carriage according to the invention in unfolded state;

FIG. 2 shows a second isometric view of the embodiment of FIG. 1 in unfolded state;

FIG. 3 shows a side view of the embodiment of FIG. 1 in unfolded state;

FIG. 4 shows a cross section of the embodiment of FIG. 1 in unfolded state;

FIG. 5 shows a isometric view of the embodiment of FIG. 1 in a first intermediate state between the unfolded state and the folded state;

FIG. 6 shows a isometric view of the embodiment of FIG. 1 in a second intermediate state between the unfolded state and the folded state;

FIG. 7 shows a isometric view of the embodiment of FIG. 1 in the folded state;

FIG. 8 shows a side view of the embodiment of FIG. 1 in the folded state; and

FIG. 9 shows a push chair with the push chair carriage of FIG. 1 and a child seat.

### DETAILED DESCRIPTION OF THE INVENTION

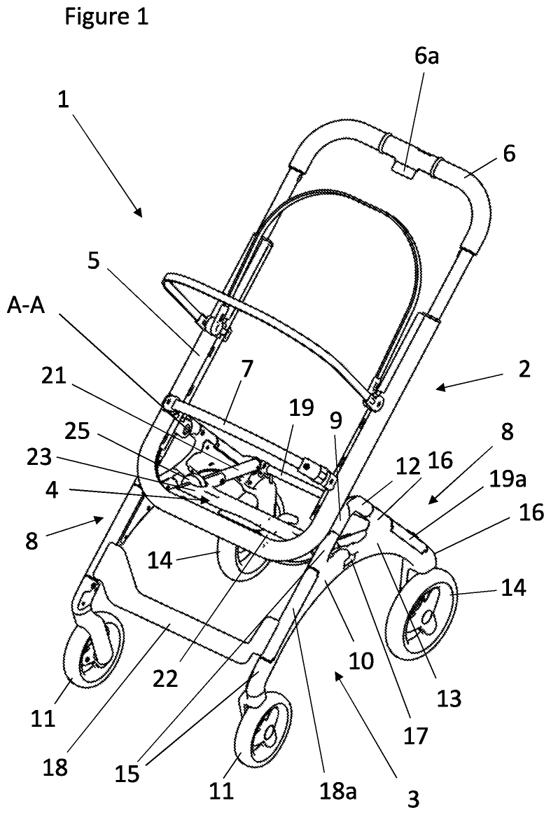

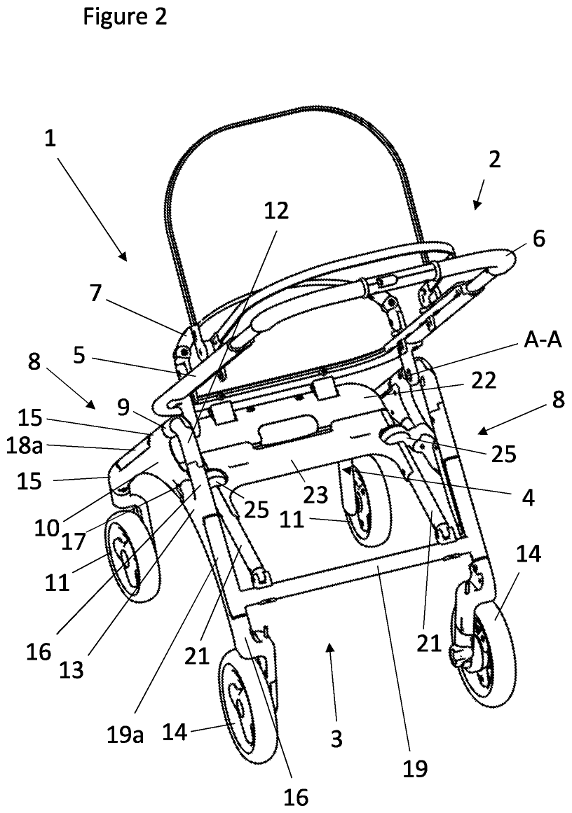

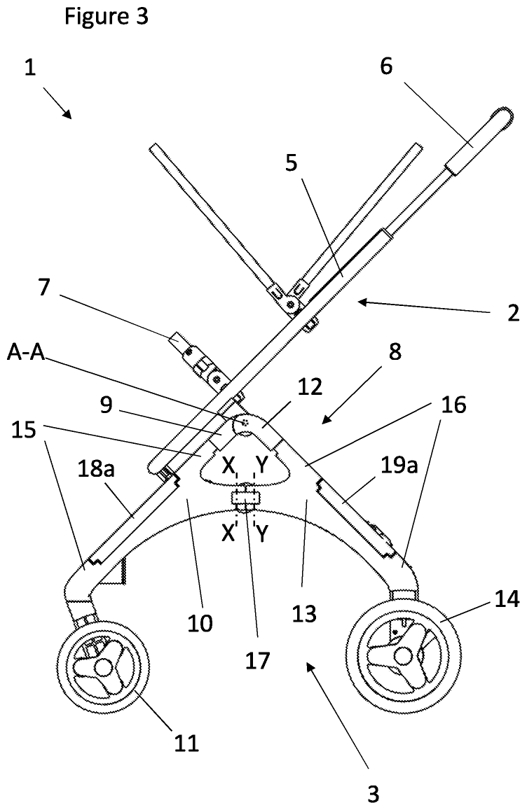

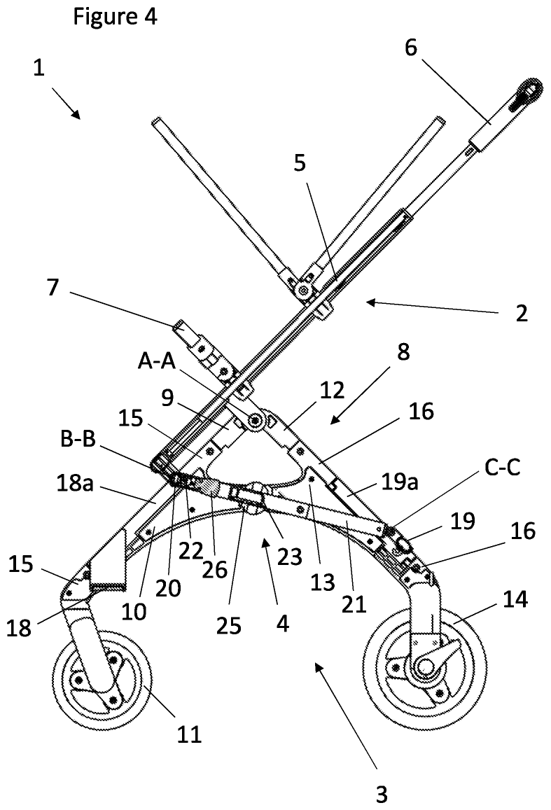

FIGS. 1 and 2 show isometric views of an embodiment of a push chair carriage according to the invention generally indicated by reference numeral 1 in the unfolded state. FIG. 3 shows a side view of the push chair carriage 1 and FIG. 4 shows a cross section of the push chair carriage 1.

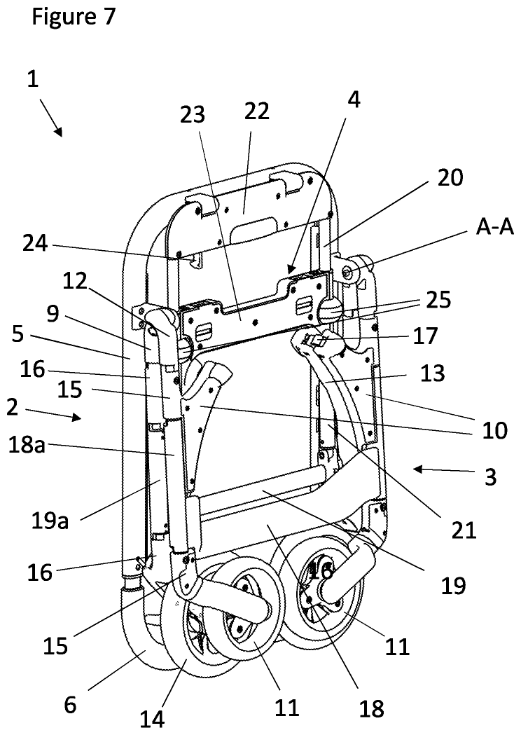

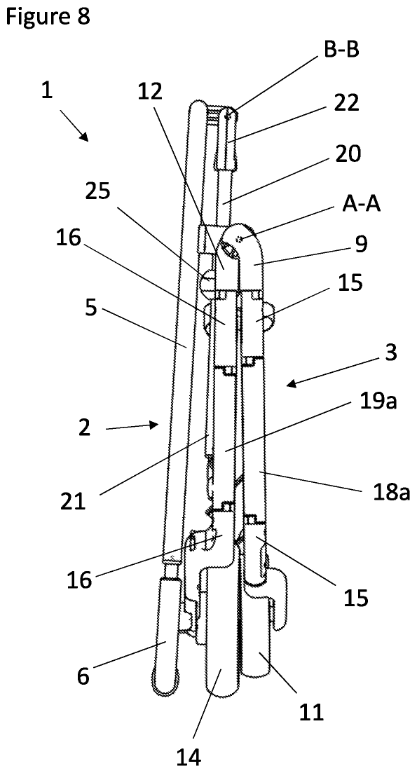

In the unfolded state, the push chair carriage 1 is configured to support a child in a seating position. The push chair carriage 1 comprises an upper frame 2 to support a child and a lower frame 3 to support the upper frame 2. The upper frame 2 is pivotably mounted on the lower frame 3 to pivot the upper frame 2 between an unfolded position as shown in FIGS. 1 and 2 and a folded position (FIGS. 7 and 8). An operating frame 4 is provided to move the upper frame 2 with respect to the lower frame 3.

The upper frame 2 comprises a U-shaped seat support part 5 and a U-shaped push bar part 6. The legs of the seat support part 5 are formed by hollow tubes and the legs of the push bar part 6 are tubes that are slidingly arranged in the hollow tubes of the seat support part 5.

By adapting the relative position of the push bar part 6 with respect to the seat support part 5, a height of the push bar part 6 may be adjusted to a desired pushing height of the push chair carriage. A push bar part locking device 6a is provided to lock a position of the push bar part 6 with respect to the seat support part 5.

The seat support part 5 can support a child seat for example made of fabric and reinforcement plates. These child seats are known in the art. The seat support part 5 further supports a removable safety rod 7. The safety rod 7 is provided to prevent that a child inadvertently falls out of the child seat.

The lower frame 3 comprises two side panels 8 extending, in the unfolded position, in a vertical plane parallel to a main drive direction of the push chair carriage 1. Each side panel 8 comprises a front support rod 9 and a front side panel part 10. A front wheel 11 is mounted on the front side panel part 10. The front wheels 11 may be swivel wheels. Each side panel 8 further comprises a back support rod 12 and a back side panel part 13. A back wheel 14 is mounted on the back side panel part 13.

The front side panel part 10 and the back side panel part 13 are plate shaped elements having a thickness substantially corresponding to the diameter of the front support rod 9 and the back support rod 12. In alternative embodiments the front side panel part 10 and the back side panel part 13 may have any other suitable shape. The front side panel part 10 and the back side panel part 13 may be plate shaped elements having a different thickness than the diameter of the front support rod 9 and the back support rod 12. Also, the front side panel part 10 and the back side panel part 13 may be formed out of rods or beams, or combinations thereof.

The front support rod 9 comprises an upper part and a lower part, wherein the lower part is rotatably mounted about its longitudinal axis with respect to the upper part. The back support rod 12 also comprises an upper part and a lower part, wherein the lower part is rotatably mounted about its longitudinal axis with respect to the upper part.

The front side panel part 10 comprises two sleeves 15 through which the lower part of the front support rod 9 extends. The sleeves 15 of the front side panel part 10 are fixed to the lower part. Due to this connection between the sleeves 15 and the lower part of the front support rod, the front side panel 10 is pivotable with respect to the upper part of the front support rod 9. Similarly, the back side panel part 13 comprises two sleeves 16 through which the back support rod 12 extends and the sleeves 16 are fixed to the lower part of the back support rod 12. Due to this connection between the sleeves 16 and the lower part of the back support rod 12, the back side panel 13 is pivotable with respect to the upper part of the back support rod 12.

It is remarked that in the Figures only the upper parts of the front support rods 9 and the back support rods 12 are visible. The lower parts of the front support rods 9 and the back support rods 12 run through the sleeves 15, 16 and sleeves 18a, 19a of a front connecting rod 18 and a back connecting rod 19.

The ends of the front side panel part 10 and the back side panel part 13 that are directed towards each other are connected to each other with a double pivot axis element 17 such that the front side panel part 10 and the back side panel part 13 are pivotable with respect to each other between an unfolded position as shown in FIGS. 1 and 2 and a folded position.

In the unfolded position the front side panel part 10 and the back side panel part 13 extend at an angle of about 180 degrees to form together with the front support rod 9 and the back support rod 12 a substantially triangular side panel 8. This side panel 8 provides a high rigidity to the lower frame 3.

The double pivot axis element 17 provides a first pivotal connection to the front side panel part 10 and a second pivotal connection to the back side panel part 13. The first pivotal connection is spaced from the second pivotal connection to allow the front side panel part 10 and the back side panel part 13 to be rotated with respect to each other until the front side panel part 10 and the back side panel part 13 can be placed next to each other, at an angle of about 0 degrees, such that the main planes of the front side panel part 10 and the back side panel part 13 extend parallel to each other. The rotation axes of the first pivotal connection and the second pivotal connection are indicated in FIG. 3 as axis X-X and Y-Y respectively.

The side panels 8 are connected to each other by the front connecting rod 18 mounted between the two front support rods 9 and the back connecting rod 19 mounted between the two back support rods 12. To allow rotation of the lower part of the front support rod 9 with respect to the front connecting rod 18, the ends of the front connecting rod 18 are provided with sleeves 18a, in which the lower part of the front support rod 9 can freely rotate. To allow rotation of the lower part of the back support rod 12 with respect to the back connecting rod 19, the ends of the front connecting rod 19 are provided with sleeves 19a, in which the lower part of the front support rod 9 can freely rotate.

It is remarked that in an alternative embodiment of the lower frame 3, the front support rods 9 and the back support rods 12 may be constructed as being non-rotatable about their longitudinal axes. In this embodiment the front support rods 9 and the back support rods 12 are not fixed to the front side panel part 10 and the back side panel part 13 so that the front side panel part 10 and the back side panel part 13 can freely rotate with respect to the front support rods 9 and the back support rods 12, respectively. Also, the sleeves 18a and 19b may be fixed to the front support rods 9 and the back support rods 12 are no longer required to rotate with respect to each other.

In the embodiment shown in the Figures, the front connecting rod 18 has been shaped to function as a feet support to support the feet of a child sitting in a child seat supported by the upper frame 2. The combination of the rigid side panels 8 and the front connecting rod 18 and the back connecting rod 19 providing a rigid connection between the two side panels 8 results in a rigid construction of the lower frame 3. This rigid construction of the lower frame 3 functions as a reliable basis for the push chair carriage 1.

At the top ends, the upper part of the front support rod 9 and the upper part of the back support rod 12 are pivotably connected to each other, such that the front support rod 9 and the back support rod 12 can rotate with respect to each other about a first rotation axis A-A. The upper frame 2 also rotates with respect to the lower frame about the first rotation axis A-A.

When the front support rod 9 and the back support rod 12 are rotated towards each other, the lower part of the front support rod 9 and the front side panel part 10 may rotate with respect to the upper part of the front support rod 9, and the lower part of the back support rod 12 and the back side panel part 13 may rotate with respect to the upper part of the back support rod 12 until the front support rod 9 and the back support rod 12 are arranged substantially parallel to each other. In this folded position, the front side panel part 10 and the back side panel part 13 extend at an angle of about 0 degrees with respect to each other.

Since the front wheels 11 and the back wheels 14 are mounted to the front side panel part 10 and the back side panel part 13, respectively, the front wheels 11 and the back wheels 14 will rotate together with the front side panel part 10 and the back side panel part 13 to the folded position in which the main planes of the front wheels 11 and the back wheels 14 are substantially parallel to the front side panel part 10 and the back side panel part 13. This allows the lower frame to fold to a relative small thickness, when brought into the folded position. Thereby, it is possible to use relatively large front wheels 11 and/or back wheels 14.

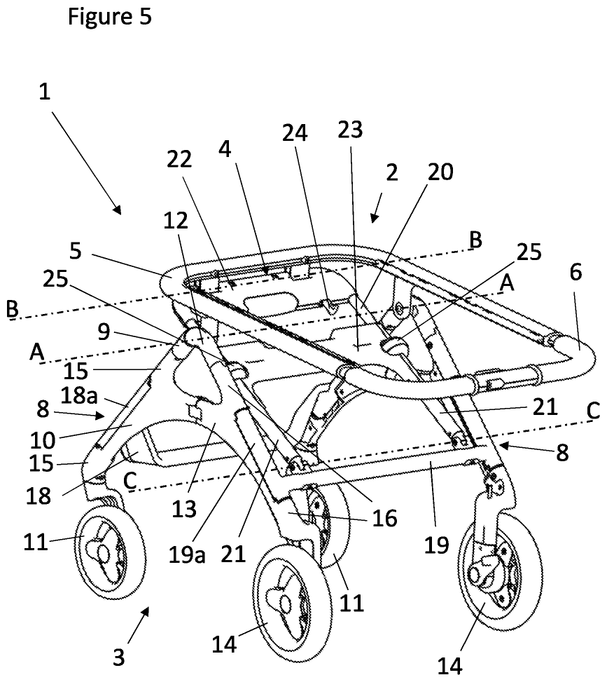

The push chair carriage 1 further comprises an operating frame 4. The operating frame 4 is a telescopic frame comprising a U-shaped tube 20 (see FIG. 5) and hollow tubes 21. The U-shaped tube 20 is pivotably, about a second rotation axis B-B, mounted to a lower end of the seat support part 5 of the upper frame 2. Each leg of the U-shaped tube 20 extends into one end of each of the hollow tubes 21. The opposite ends of the hollow tubes 21 are pivotably mounted, about a third rotation axis C-C, to the back connecting rod 19.

The operating frame 4 comprises a locking device having a first locking device part 22 and a second locking device part 23. The first locking device part 22 is mounted on the U-shaped tube 20 and the second locking device part 23 is mounted between the two hollow tubes 21. In FIG. 4, the locking device is shown in locked position, whereby the first locking device part 22 and the second locking device part 23 are placed against each other. The first locking device part 22 comprises a hook 24 (see FIG. 5) that snaps into the second locking device part 23 to hold the first locking device part 22 and the second locking device part 23 together.

As long as the first locking device part 22 and the second locking device part 23 will stay in the position shown in FIG. 4, the length of the operating frame 4 will not change and the upper frame 2 will stay in the same position with respect to the lower frame 3.

On each of the hollow tubes 21 a roller 25 is provided that, in the unfolded state, is positioned next to the double pivot axis element 17 to hold the front side panel part 10 and the back side panel part 13 of the respective side panel 8 in the unfolded position. Due to the locking device, the rollers 25 will remain in the same position. This ensures that the side panels 8 will not inadvertently move towards the folded position. It is remarked that when the side panel 8 is moved from the folded position to the unfolded position, the rollers 25 will help to push the front side panel part 10 and the back side panel part 13 to the unfolded position.

It is remarked that rotation limiters may be provided to limit rotation of the front side panel part 10 and the back side panel part 13. The rotation limiters may in particular be adapted to prevent movement of the front side panel part 10 and the back side panel part 13 from the unfolded position away from the rollers 25, or more generally in a direction away from the intended folded position of the front side panel part 10 and the back side panel part 13.

To unlock the locking device such that movement of the first locking device part 22 away from the second locking device part 23 is possible, the push bar part 6 of the upper frame 2 may be pushed into the seat support part 5. This will move the hook 24 sideways out of the snap connection with the second locking device part 23, such that the first locking device part 22 can be moved away from the second locking device part 23.

When the locking device is no longer locked the upper frame 2 can be tilted about the first rotation axis A-A.

FIG. 5 shows the push chair carriage 1 in an intermediate state between the unfolded state and the folded state. It can be seen that the rollers 25 on the hollow tubes 20 have been moved upwards so they are no longer positioned next to the double pivot axis element 17. This means that the front side panel part 10 and the back side panel part 13 are no longer blocked to move towards the folded position.

To help the movement of the front side panel part 10 and the back side panel part 13 towards the folded position, a biasing element such as a pre-tensioned rubber element may be provided in or next to the double pivot axis element 17 so that the front side panel part 10 and the back side panel part 13 of each side panel 8 start to move towards the folded position as soon as the rollers 25 do no longer prevent such movement.

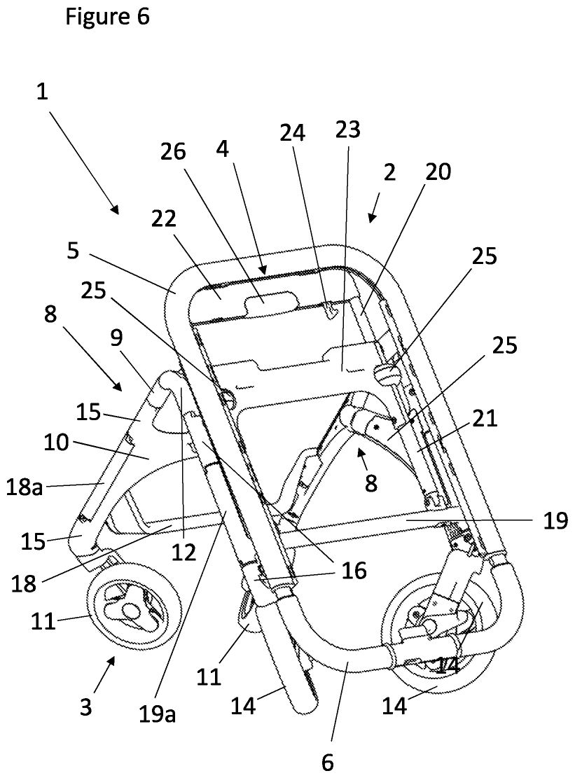

FIG. 6 shows the push chair carriage 1 when the upper frame 2 is further rotated with respect to the lower frame 3 about the first rotation axis A-A to a second intermediate state. In this second intermediate position, the legs of the U-shaped seat support part 5 of the upper frame 2 lie adjacent and parallel to the back support rods 12 of both side panels 8. It can also clearly be seen that the front side panel part 10 and the back side panel part 13 are no longer extending in the same plane, i.e. at an angle of about 180 degrees, but are pivoted with respect to each other. Also, since the front wheels 11 are mounted on the front side panel part 10 and the back wheels 14 are mounted on the back side panel part 13, the front wheels 11 and the back wheels 14 follow the rotation of the front side panel part 10 and the back side panel part 13, respectively.

Since the U-shaped seat support part 5 of the upper frame 2 lie adjacent and parallel to the back support rods 12 of both side panels 8, the upper frame 2 can now not be rotated further with respect to the lower frame 3. To further fold the push chair carriage 2 the push chair carriage 2 can be lifted by the user when holding the child seat carriage 2 at the hand grip 26 provided on the first locking device part 22.

When the push chair carriage 1 is lifted by pulling it upwards from the position shown in FIG. 6, while holding it at the handle grip 26, the side panels 8 will further fold until the front side panel part 10 and the back side panel part 13 are arranged next to each other in the folded position.

FIG. 7 shows the push chair carriage 1 in the folded state in which the side panels 8 are completely folded. The front wheels 11 and the back wheels 14 are rotated together with the front side panel part 10 and the back side panel part 13, respectively, so that the main planes of the front wheels 11 and the back wheels 14 are parallel with the plane in which the front side panel part 10 and the back side panel part 13 extend.

Thus, in the folded state of the push chair carriage 1, the upper frame 2, the front side panel parts 10, the back side panel parts 13, the front wheels 11 and the back wheels 14 are arranged substantially parallel to each other and on top of each other.

FIG. 8 shows a side view of the push chair carriage 1 in the folded state. It can be seen that in the folded state, the push chair carriage 1 provides a package with a relatively low thickness. Such package is very suitable for storage and/or transport of the push chair carriage 1. It is remarked that the front wheels 11 and back wheels 14 may be relatively big, while the push chair carriage 1 can still be folded into a package with a relatively low thickness.

The push chair carriage 1 can be moved from the folded state to the unfolded state by rotation of the upper frame 2 with respect to the lower frame 3 from the folded position to the unfolded position. The rotation of the upper frame 2 will cause the hollow tubes 21 of the operational frame 4 to push against the back side panel parts 13. This will initiate the movement of the front side panel part 10 and the back side panel part 13 from the folded position towards the unfolded position. At the end of this movement the rollers 25 will push the front side panel part 10 and the back side panel part 13 in the unfolded position, where the rotation limiters will prevent that the front side panel part 10 and the back side panel part 13 will move past the unfolded position.

An advantage of the push chair carriage 1 as described above is that the push chair carriage 1 can be moved with a single hand from the unfolded state to the folded state and back from the folded state to the unfolded state.

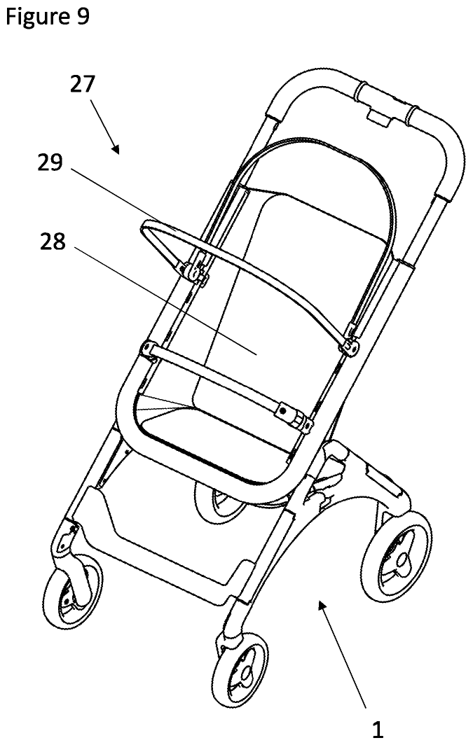

FIG. 9 shows a push chair 27 comprising the push chair carriage 1 shown in FIGS. 1-8, and a child seat 28 mounted on the seat support part 5 of the upper frame 2. In practice the child seat 28 may remain on the child seat carriage 1 when the child seat carriage 1 is arranged in the folded state. The child seat is preferably made of flexible material such as cloth, fabric, or textile and may be provided with reinforcement elements such as plates. The reinforcement elements should not prevent the child seat carriage 1 to be moved to the folded state.

The push chair 1 further comprises a removable canopy 29 mounted on the upper frame 2. In the Figures only the canopy frame is shown, but in practice a flexible cloth will be mounted on the canopy frame to form a canopy 29.

### REFERENCE NUMERALS

1 push chair carriage

2 upper frame

3 lower frame

4 operational frame

5 seat support part

6 push bar part

6a push bar part locking device

7 safety rod

8 side panel

9 front support rod

10 front side panel part

11 front wheel

12 back support rod

13 back side panel part

14 back wheel

15 front support rod sleeve

16 back support rod sleeve

17 double pivot axis element

18 front connecting rod

18a sleeve of front connecting rod

19 back connecting rod

19a sleeve of back connecting rod

20 U-shaped tube

21 hollow tube

22 first locking device part

23 second locking device part

24 hook

25 roller

26 hand grip

27 push chair

28 child seat

29 canopy

A-A first rotation axis

B-B second rotation axis

C-C third rotation axis

1. A foldable push chair carriage that can be arranged in a folded state and an unfolded state comprising:
an upper frame to support a child,
a lower frame to support the upper frame,
wherein the upper frame is pivotable with respect to the lower frame about a first rotation axis,
wherein that the lower frame comprises two side panels connected to each other by one or more connecting rods,
wherein each side panel comprises a front side panel part and a back side panel part,
wherein the front side panel part and the back side panel part are pivotable with respect to each other between an unfolded position in which the front side panel part and the back side panel part extend at an angle of 160-180 degrees with respect to each other and a folded position in which the front side panel part and the back side panel part extend at an angle of 0-30 degrees with respect to each other, and
wherein each side panel comprises a front wheel and a back wheel.

2. The push chair carriage of claim 1,
wherein each side panel comprises a front support rod and a back support rod, and
wherein one end of the front support rod and one end of the back support rod are pivotably connected to each other.

3. The push chair carriage of claim 2, wherein the front support rod and back support rod are pivotable about the first rotation axis.

4. The push chair carriage of claim 2,
wherein at least one of the one or more connecting rods is mounted between the front support rod of one side panel and the front support rod of the other side panel, and
wherein at least one of the one or more connecting rods is mounted between the back support rod of one side panel and the back support rod of the other side panel.

5. The push chair carriage of claim 2,
wherein the front support rod comprises an upper part and a lower part, wherein the lower part is rotatably mounted about its longitudinal axis with respect to the upper part, and wherein the lower part is fixedly mounted to the front side panel part,
wherein the back support rod comprises an upper part and a lower part, wherein the lower part is rotatably mounted about its longitudinal axis with respect to the upper part, and wherein the lower part is fixedly mounted to the back side panel part,
wherein one end of the upper part of the front support rod and one end of the upper part of the back support rod are pivotably connected to each other, and
wherein the front side panel part and the back side panel part are pivotably connected to each other by a pivot element.

6. The push chair carriage of claim 2,
wherein the front side panel part is pivotably mounted on the front support rod and the back side panel part is pivotably mounted on the back support rod, and
wherein the front side panel part and the back side panel part are pivotably connected to each other by a pivot element.

7. The push chair carriage of claim 6, wherein the pivot element is a double pivot axis element, wherein one end of the double pivot axis element is pivotably connected to the front side panel part and the other opposite end of the double pivot axis element is pivotably connected to the back side panel part.

8. The push chair carriage of claim 1, wherein the front wheel is mounted on the front side panel part and the back wheel is mounted on the back side panel part.

9. The push chair carriage of claim 1, wherein the upper frame comprises a seat support part to support a child seat and a push bar part configured to push the push chair.

10. The push chair carriage of claim 9, wherein the seat support part and the push bar part are substantially U-shaped having legs, and wherein the legs of the push bar part are telescopically arranged in or on the legs of the seat support part.

11. The push chair carriage of claim 1,
wherein the push chair carriage comprises a telescopic operating frame,
wherein one end of the operating frame is pivotably about a second rotation axis mounted to the upper frame and another end of the operating frame is pivotably about a third rotation axis mounted to the lower frame, and
wherein the first rotation axis, the second rotation axis and the third rotation axis are parallel and spaced from each other.

12. The push chair carriage of claim 1, wherein the upper frame is rotatable about the first rotation axis between a folded position and an unfolded position.

13. The push chair carriage of claim 11, wherein the operating frame is configured to push the front side panel part and the back side panel part of each side panel from the folded position towards the unfolded position, when the upper frame is moved from the folded position towards the unfolded position.

14. The push chair carriage of claim 1, wherein the push chair carriage comprises a locking device to lock the push chair carriage in the unfolded position.

15. The push chair carriage of claim 1, wherein, in the folded state of the push chair carriage, the upper frame, the front side panel parts, the back side panel parts, the front wheels and the back wheels are arranged substantially parallel to each other.

16. The push chair carriage of claim 1, wherein the side panel comprises a biasing element to bias the front side panel part and the back side panel part from the unfolded position at least partially towards the folded position.

17. A foldable push chair comprising:
the push chair carriage of claim 1, and
a child seat supported by the upper frame of the push chair carriage.
